(19) United States
(12) Patent Application Publication
(10) Pub. No.: US 2014/0363137 A1
(43) Pub. Date: Dec. 11, 2014

(54) Generating a Geo-Located Data Movie from Certain Data Sources

(71) Applicants: Stefan B. KUHNE, San Jose, CA (US); Vermont T. LASMARIAS, Fremont, CA (US); Quarup S. BARREIRINHAS, San Francisco, CA (US)

(72) Inventors: Stefan B. KUHNE, San Jose, CA (US); Vermont T. LASMARIAS, Fremont, CA (US); Quarup S. BARREIRINHAS, San Francisco, CA (US)

(73) Assignee: Google Inc., Mountain View, CA (US)

(21) Appl. No.: 13/289,253

(22) Filed: Nov. 4, 2011

(51) Int. Cl. H04N 9/80

(52) U.S. Cl. 386/239; 386/E09.011

(57) ABSTRACT

Systems, methods, and computer storage mediums are provided for requesting a geo-referenced interactive tour using media objects collected from a plurality of users. An exemplary method includes accessing a plurality of selected user profiles. Each user profile is associated with one or more users. Media objects hosted by the selected user profiles are clustered into trip segments based on a velocity value associated with each media object. Geo-referenced data for at least one trip segment is collected based on a first and last media object associated with the trip segment. The trip segments are combined into the digital video. Each trip segment is rendered to include its associated media objects and geo-referenced data. Each trip segment is rendered according to a presentation style that is selected based on its associated media objects.

### FIELD OF THE INVENTION

The field of the invention generally relates to creating an interactive three dimensional tour that can be rendered to a digital video.

### BACKGROUND

Systems currently exist that allow a user to collect and share digital media. These systems allow the user to upload digital media to the user's profile on a website. The user can choose to share some or all of the digital media with other users. These systems also allow a user to post information that can also be shared with other users. Users wishing to view the media posted from other users must navigate to each website hosting the media and view the user's profile.

### BRIEF SUMMARY

As a user or a group of users travel to, and about a destination, the digital media created during their travels are not easily merged together and shared in either an interactive tour or a digital video. The embodiments described herein provide systems and methods that allow a user create an interactive three dimensional tour that can be rendered as a digital video. The interactive tour may include media from the group of users. The interactive tour is generated by collecting media from the users' profiles on various media sources, clustering the media into segments based on date or time, and rendering the segments according to a presentation style.

The embodiments described herein include systems, methods, and computer storage mediums for requesting an interactive tour using media objects collected from a plurality of users. An exemplary method includes, in response to a request to generate a digital video, accessing a plurality of selected user profiles. Each user profile is associated with one or more users and each user profile hosts one or more media objects stored on at least one media source. One or more media objects hosted by each selected user profile is clustered into one or more trip segments based on a velocity value associated with each media object. The velocity value indicates the velocity of travel between two media objects. Each trip segment includes a first media object representing a start of the trip segment and a last media object representing an end of the trip segment. Geo-referenced data for at least one trip segment is collected based on at least the first media object and the last media object associated with the trip segment. The geo-referenced data depicts one or more users traveling between the geolocation associated with the first media object and the geolocation associated with the last media object. One or more rendered trip segments are combined into the interactive tour. Each trip segment is rendered to include its associated media objects and geo-referenced data. Each trip segment is rendered according to a presentation style that is selected, in part, based on its associated media objects.

Further features and advantages of the embodiments described herein, as well as the structure and operation of various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 illustrates an example system environment that may be used to request a geo-referenced interactive tour using media objects collected from a plurality of users.

FIG. 2 is a flowchart illustrating an exemplary method that may be used to request a geo-referenced interactive tour using media objects collected from a plurality of users.

FIG. 3 illustrates an exemplary group of segments that is the result of clustering media objects according to an embodiment.

FIG. 4 illustrates an exemplary storyboard that represents a geo-referenced digital video that is generated according to an embodiment.

FIG. 5 illustrates an example computer in which embodiments of the present disclosure, or portions thereof, may be implemented as computer-readable code.

### DETAILED DESCRIPTION

In the following detailed description, references to “one embodiment,” “an embodiment,” “an example embodiment,” etc., indicate that the embodiment described may include a particular feature, structure, or characteristic. Every embodiment, however, may not necessarily include the particular feature, stricture, or characteristic. Thus, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The following detailed description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

The embodiments described herein make reference to a “media object.” Media objects include, but are not limited to, photographic images, digital videos, microblog and blog posts, audio files, documents, text, or any other type of digital media. A person of skill in the art will readily recognize the types of data that constitute media objects.

This Detailed Description is divided into sections. The first and second sections describe example system and method embodiments that may be used to request a geo-referenced digital video using media objects collected from a plurality of users. The third section describes an exemplary group of trip segments organized by an embodiment. The fourth section describes an exemplary storyboard that represents a digital video that is generated according to an embodiment. The fifth section describes an example computer system that may be used to implement the embodiments described herein.

### Example System Embodiments

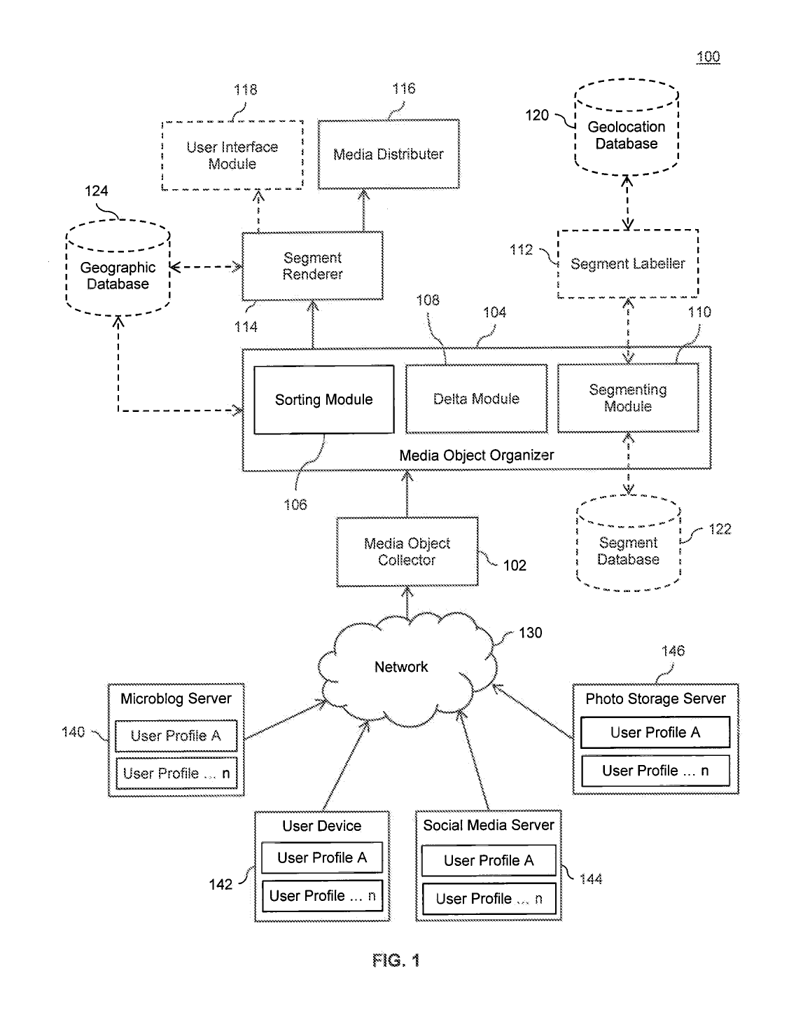

FIG. 1 illustrates an example system environment 100 that may be used to request a geo-referenced interactive tour using media objects collected from a plurality of users. System 100 includes media object collector 102, media object organizer 104, segment labeller 112, segment renderer 114, media distributer 116, user-interface module 118, geolocation database 120, segment database 122, geographic database 124, network 130, microblog server 140, user device 142, social media server 144, and photo storage server 146. Media object organizer 104 includes sorting module 106, delta module 108, and segmenting module 110.

Network 130 can include any network or combination of networks that can carry data communication. These networks can include, for example, a local area network (LAN) or a wide area network (WAN), such as the Internet. LAN and WAN networks can include any combination of wired (e.g., Ethernet) or wireless (e.g., Wi-Fi, 3G, or 4G) network components.

Microblog server 140, user device 142, social media server 144, and photo storage server 146 can be implemented on any computing device capable of capturing, creating, storing, sharing, distributing, or otherwise transmitting media objects. These devices can include, for example, stationary computing devices (e.g., desktop computers), networked servers, and mobile computing devices such as, for example, tablets, smartphones, or other network enabled portable digital devices. Computing devices may also include, but are not limited to, a central processing unit, an application-specific integrated circuit, a computer, workstation, distributed computing system, computer cluster, embedded system, stand-alone electronic device, networked device, mobile device (e.g. mobile phone, smart phone, personal digital assistant (PDA), navigation device, tablet or mobile computing device), rack server, set-top box, or other type of computer system having at least one processor and memory. Microblog server 140, user device 142, social media server 144, and photo storage server 146 can also each store one or more user profiles with each user profile being associated with one or more users.

Media object collector 102, media object organizer 104, sorting module 106, delta module 108, segmenting module 110, segment labeller 112, segment renderer 114, media distributer 116, user-interface module 118, geolocation database 120, segment database 122, and geographic database 124 can be implemented on any computing device. Each component, module, or database may run on single computing device or a distribution of computer devices.

A. Media Object Collector

Media object collector 102 is configured to access a plurality of selected user profiles. The user profiles can be selected from any media source that utilizes user profiles to store, distribute, or share media objects. Such media sources can include, for example, microblog server 140, user device 142, social media server 144, and photo storage server 146. Each user profile can be associated with one or more users and each user may be associated with one or more user profiles on each media source. Each user profile can be used to share, store, or distribute information and/or media objects.

In some embodiments, media object collector 102 receives a collection of media objects from a plurality of users. For example, if a user wishes to view an interactive tour or a digital video that includes media objects generated by other users, the user may select to include these media objects in the interactive presentation. To collect these media objects, media object collector 102 may access the user profiles associated with the other users. The other users' profiles may be accessible through one of the user's profiles. For example, if the user has a user profile on social media server 144 that allows the user to view other users' profiles, media object collector 102 may access the other users' profiles through the user's profile and collect the other users' media objects. The media objects are collected in a way that respect the privacy and sharing settings associated with users' profiles. Media objects may also be collected from other media sources by using the user's profile on the other media sources.

In some embodiments, media object collector 102 retrieves media objects from user profiles hosted by a selected group of media sources. The group of selected media sources may be based on, for example, user input or media object type. In some embodiments, media object collector 102 collects the media objects by creating a list that includes the media objects and a description where each media object is located. The description can include, for example, a URL, a filename, or another type of address, locator, or link.

In some embodiments, media object collector 102 is configured to automatically access one or more user profiles stored on one or more media sources. The media objects hosted by the user profiles can then be retrieved based on a date and time range, a geolocation range, or user preferences. For example, if a user requests a digital video that includes media objects created by a group of users within a specific time period and/or around a selected geolocation, media object collector 102 will collect all available media object from the users' profiles that fall within the selected time period and/or a geolocation range encompassing the geolocation. Similarly, if the user requests a digital video using media objects collected from the user's family members, media object collector 102 will access the user's preferences to identify the profiles that are associated with the user's family members on each media source.

B. Media Object Organizer

Media object organizer 104 is configured to cluster media objects into one or more trip segments. The media objects are clustered based on a velocity value associated with each collected media object. The velocity value is calculated using a time value and a geolocation associated with each collected media object. Each trip segment includes a first media object representing the start of the trip segment and a last media object representing the end of the trip segment. In some embodiments, the media objects are clustered using segmenting module 110, described below.

Media object organizer 104 is also configured to collect geo-referenced data for each trip segment. The geo-referenced data depicts one or more users traveling between the geolocations associated with the first and last media objects. The geo-referenced data can include, for example, 3D imagery, maps, addresses, panoramic or other photographic images, location names, or other geo-referenced data. In some embodiments, the geolocations associated with the first and last media objects are used to collect geo-referenced data from a geographic information system such as, for example, geographic database 124.

In some embodiments, media object organizer 104 is also configured to cluster media objects into at least one trip segment based on a user profile. For example, if media objects are collected from various user profiled, media object organizer 104 can cluster the media objects associated with the same user profile into the same trip segment. Similarly, media object organizer 104 can cluster media objects associated with the same media source, regardless of the user, into the same trip segment.

In some embodiments, media object organizer 104 is also configured to cluster media objects into at least one trip segment based on one or more users associated with a media object. For example, if media objects from various users are collected, media object organizer 104 can cluster the media objects associated with the same user, regardless of user profile or media source, into the same trip segment.

Media object organizer 104 includes sorting module 106, delta module 108, and segmenting module 110. These modules may be utilized to carry out the clustering and collecting functionality described above. These modules, however, are not intended to limit the embodiments. Consequently, one of skill in the art will readily understand how the functionality of each module may be implemented by using one or more alternative modules or configurations.

Media object organizer 104 may be further configured to carry out the embodiments described in U.S. patent application Ser. No. ______ (Attn. Dkt. No. 2525.7340000), incorporated herein in its entirety.

1. Sorting Module

In some embodiments, sorting module 106 is configured to sort the media objects based on the time value associated with each media object, prior to the media objects being clustered into trip segments. The time value may be included in metadata associated with each media object. In some embodiments, the time value indicates when a media object was created. In some embodiments, the time value includes separate date and time values. In some embodiments, the time value indicates time relative to a starting date and time. In some embodiments, the time value adjusts automatically for time zones and locality specific changes such as, for example, daylight saving time.

The time value is normally determined based on when the media object is created. For example, if the media object is a photographic image, the time value will indicate when the photographic image is captured. If the media object is a microblog post, the time value will indicate when the post is received by, for example, microblog server 140, and added to a user's profile. A person of skill in the art will readily understand how to determine an appropriate time value for each type of media object. The time value may also be based on some other event such as, for example, when a media object is modified.

In some embodiments, sorting module 106 will sort the media object in chronological order from oldest to newest based on the time value. In some embodiments, sorting module 106 will sort the media objects in reverse chronological order. In some embodiments, sorting module 106 will sort the media objects based on similar creation times distinct from the creation date.

These embodiments are merely exemplary and are not intended to limit sorting module 106.

2. Delta Module

In some embodiments, after the media objects are sorted, delta module 108 is configured to determine a delta between adjacent media objects. The delta includes a distance value describing the distance between adjacent media objects. The distance value between adjacent media objects is based on a difference between a geolocation associated with each media object. For example, a collection of sorted media objects may include object1, object2, object3, etc. Delta module 108 can determine the distance value between object1 and object2 as well as between object2 and object3. For larger collections of sorted media objects, the process is continued for each two adjacent media objects.

The geolocation associated with each media object can include, for example, latitude/longitude coordinates, addresses, or any other coordinate system. The geolocation can also include altitude values. In some embodiments, the geolocation for each media object is based on where the media object was created. For example, if the media object is a photographic image, the geolocation is based on where the image was captured. If the media object is an audio file, the geolocation is based on where the audio file was recorded. If the media object is a blog post, the geolocation is based on a user's location when creating the blog post. In some embodiments, the geolocation is set or modified based on user input.

In some embodiments, the geolocation is determined by a computer device used to create the media object. These computer devices can utilize location services such as, for example, global positioning system (GPS) services or a network based location service. In some embodiments, the geolocation is based on user input. In some embodiments, a combination of user input and a location service are utilized.

In some cases, not all media objects include a geolocation. For these cases, a number of methods may be used to supplement the media objects missing a geolocation. In some embodiments, each media object without a geolocation may copy a geolocation from an adjacent media object based on a duration between the time value. For example, if object2, described above, does not include a geolocation, it may utilize the geolocation from either object1 or object3, depending on which object was created within a shorter duration. If object1 and object3 have no geolocation, object 2 can utilize the geolocation from the next closest adjacent object with a geolocation. In some embodiments, delta module 108 may be configured to skip over media objects missing geolocations and determine a distance value only between the closest, adjacent media objects with a geolocation.

In some embodiments, delta module 108 also determines a velocity value. The velocity value is based on the duration between the time values and the distance between geolocations associated with each two adjacent media objects. The velocity value is intended to show the speed at which a user travels between the geolocations associated with adjacent media object. For example, if the distance value between object1 and object2 is 60 miles and the duration between object1 and object2 is one hour, the velocity value between object1 and object2 is 60 miles per hour. The velocity value may be represented in any appropriate format and is not limited to the foregoing example.

In some embodiments, a velocity value is used to determine a mode of transportation between adjacent media objects. For example, a velocity value over 100 miles per hour may indicate that the mode of transportation is an airplane. A velocity value between 20 miles per hour and 100 miles per hour may indicate that the mode of transportation is an automobile. A velocity value between 5 miles per hour and 20 miles per hour may indicate that the mode of transportation is a bicycle. A velocity value between 1 mile per hour and 5 miles per hour may indicate that the mode of transportation is walking or hiking. And, a velocity value under 1 mile per hour may indicate that the mode of transportation is mostly stationary. These velocity ranges may be modified to include other modes of transportation and are not intended to limit the embodiments in any way.

3. Segmenting Module

In some embodiments, segmenting module 110 is configured to cluster one or more sorted media objects into one or more trip segments based on the velocity value between adjacent media objects. The clustering process can occur after delta module 108 determines a velocity value between each two adjacent media objects. In some embodiments, the media objects are clustered into trip segments based on similar velocity values. In some embodiments, the media objects are clustered into trip segments based on velocity value ranges. For example, as segmenting module 110 scans the sorted media objects, it encounters a contiguous group of media objects with velocity values between 20 and 100 miles per hour. This group of media objects is clustered into a first trip segment. Segmenting module 110 then encounters a velocity value between a first and second media object that is 10 miles per hour. When this velocity value is encountered, segmenting module 110 will begin a new trip segment that will start with the second media object and will include the adjacent contiguous media objects with velocity values between 5 and 20 miles per hour. This process will continue until each media object is included in a trip segment.

In some embodiments, segmenting module 110 is farther configured to merge a smaller trip segment with an adjacent trip segment based on the accuracy of the geolocation associated with each media object. For example, if a media object's geolocation results in a velocity value that is inconsistent with neighboring velocity values, segmenting module 110 will merge the media object with a neighboring trip segment. If the resulting neighboring trip segments have velocity values within the same range, segmenting module 110 may also merge these trip segments.

In some embodiments, segmenting module 110 will store each trip segment in, for example, segment database 122.

C. Segment Renderer

Segment renderer 114 is configured to combining one or more rendered trip segments into an interactive tour. Each trip segment and is rendered to include the media objects and the geo-referenced data associated with its trip segment. In some embodiments, the geo-referenced data includes a map that pans between the geolocations associated with one or more included media objects. In some embodiments, the geo-referenced data includes a movie of a virtual 3D landscape navigating a virtual path between points corresponding to the geolocations associated with one or more included media objects. In some embodiments, the geo-referenced data includes a photographic image capturing at least one geolocation associated with at least one included media object. In some embodiments, the geo-referenced data includes labels, addresses, or other information that corresponds to the geolocation associated with one or more included media objects.

Each trip segment is rendered according to a presentation style that is selected, in part, based on the media objects included in its corresponding trip segment. Presentation styles describe how media objects are presented in the interactive tour. The presentation styles also describe how media objects are presented in conjunction with the geo-referenced data. For example, if a trip segment includes photographic images and a microblog post, a presentation style can be selected that uses the microblog post for a title of the video segment and displays the photographic images as a slideshow in the video segment. If the trip segment includes geo-referenced data that navigates a path between points in a 3D geographic environment, a presentation style may be selected that overlays each photographic image at the point along the path that corresponds to its geolocation.

In some embodiments, presentation styles for each trip segment are selected automatically based on the trip segment's included media objects. In some embodiments, the presentation style of at least one trip segment is selected by the user. In some embodiments, the presentation styles can be modified by the user.

In some embodiments, segment renderer 114 is also configured to render the interactive tour into a digital video. The digital video can include any video playable by a computer system. The digital video may also be interactive.

In some embodiments, segment renderer 114 is also configured to determine a duration for at least one trip segment based on the time values associated the media objects included in its trip segment. The duration is used to determine the amount of time to dedicate to the segment when the interactive tour is rendered into a digital video. For example, if media objects included in a trip segment span a duration of one day and the duration between all of the media objects span three days, segment renderer 114 will dedicate one third of the digital video's duration will be dedicated to the video segment. In some embodiments, the duration dedicated to the trip segment can be further determined based on the duration between media objects in other trip segments to be included in the digital video. In some embodiments, the duration dedicated to the trip segment can be selected by the user.

D. Media Distributer

System 100 also includes media distributer 116. Media distributer 116 is configured to provide the interactive tour to a user based on a request to generate the interactive tour. The request to generated the interactive tour can be received by, for example, user-interface module 118. In some embodiments, the interactive tour is provided to the user as a post to the user's profile on a social media website. In some embodiments, the interactive tour is provided to the user as a data file streamed through an internet browser over network 130. In some embodiments, the interactive tour is provided to the user as a downloadable digital file.

In some embodiments, media distributer 118 is also configured to provide the digital video to the user based on a request to generate the digital video. The digital video can be provided in the same manner as the interactive tour. These embodiments are provided as examples and are not intended to limit how digital videos may be provided to the user.

E. Segment Labeller

In some embodiments, system 100 includes segment labeller 112. Segment labeller 112 is configured to label a trip segment and/or at least one media segment included in the trip segment based on the geolocations associated the media objects. Segment labeller 112 may utilize reverse geocoding to determine a label based on the geolocation. Labels can include, but are not limited to, location names, business names, political designations, addresses, or any other label that can be determined based on reverse geocoding. Labels can be retrieved from a database such as, for example, geolocation database 122. Geolocation database 122 can be any geographic information system such as, for example, geographic database 124. Geolocation database 122 may also be a stand-alone geographic information system for reverse-coding geolocations into labels.

In some embodiments, segment labeller 112 is further configured to label a trip segment based on the geolocations associated with the first and last included media objects. For example, if a first media object is created at a first geolocation and, after traveling in an airplane, a last media object is created at a second geolocation, segment labeller 112 can utilize the first and second geolocations to derive a label that indicates airplane travel between the geolocations.

F. User-Interface Module

In some embodiments, system 100 includes user-interface module 118. User-interface module 118 is configured to receive a start time and an end time from a user. The start and end times describe a time range that may include date ranges as weft. In some embodiments, the time range is provided by the user. Media object collector 102 may utilize this time range to collect media objects. For example, if the user selects a time range consisting of a three day period, media object collector 102 can collect media objects based on whether the media objects' time values fall within the three day period. In some embodiments, the user can select a starting date and time and media object collector 102 will collect all media objects from the selected user profiles from the starting date and time to the user's present time.

In some embodiments, user-interface module 118 is also configured to receive a video duration that is used to determine the digital video's duration. The video duration can be provided to segment renderer 110 and used to determine how much time to dedicate to each video segment included in the digital video.

Various aspects of embodiments described herein can be implemented by software, firmware, hardware, or a combination thereof. The embodiments, or portions thereof, can also be implemented as computer-readable code. The embodiment in system 100 is not intended to be limiting in any way.

### Example Method Embodiments

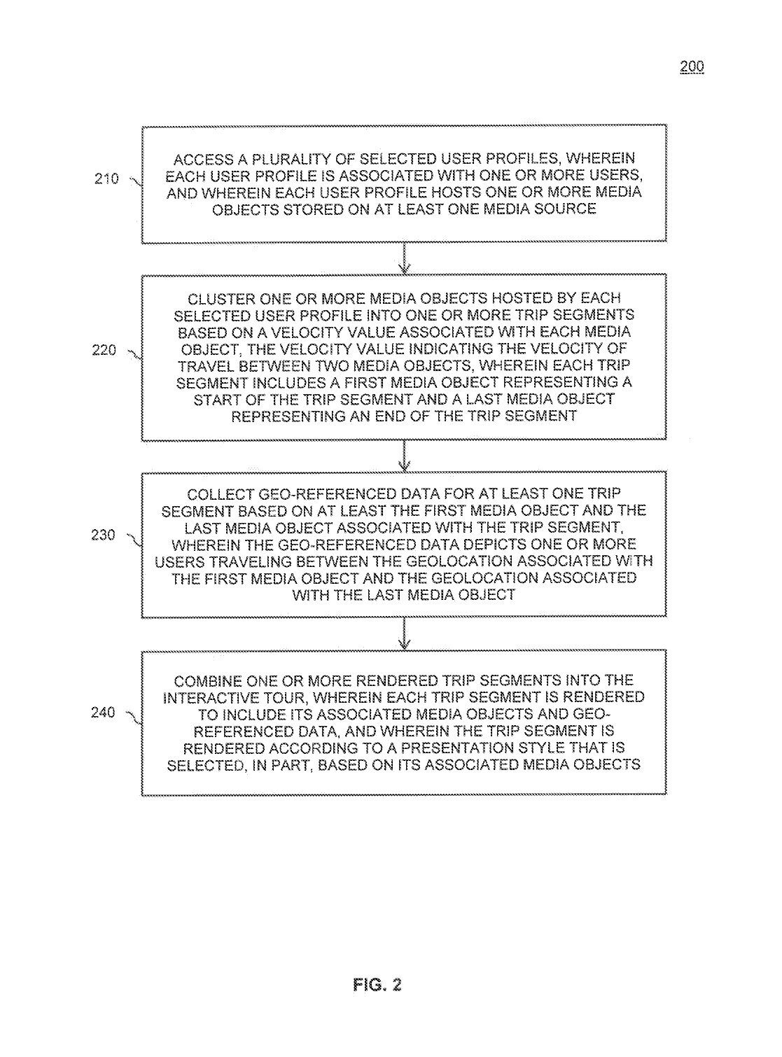

FIG. 2 is a flowchart illustrating an exemplary method that may be used to request a geo-referenced interactive tour using media objects collected from a plurality of users. While method 200 is described with respect to an embodiment, method 200 is not meant to be limiting and may be used in other applications. Additionally, method 200 may be carried out by, for example, system 100.

Method 200 first accesses a plurality of selected user profiles, where each user profile is associated with one or more users (stage 210). Each user profile includes at least one media source and may host one or more media objects. In some embodiments, the user profiles are selected by the user. In some embodiments, the user profiles are selected based on the user's profile. In some embodiments, user profiles are selected based on the user's preferences, Stage 210 may be carried out by, for example, media object collector 102 embodied in system 100.

Method 200 then clusters one or more media objects hosted by each selected user profile into one or more trip segments (stage 220). The media objects are clustered based on a velocity value associated with each collected media object. The velocity value is calculated using a time value and a geolocation associated with each collected media object. In some embodiments, the media objects are sorted based on the time value prior to being clustered. Once sorted, a velocity value between adjacent media objects is determined. Each trip segment includes a first media object representing the start of the trip segment and a last media object representing the end of the trip segment. Stage 220 may be carried out by, for example, media object organizer 104 embodied in system 100.

Method 200 also collects geo-referenced data for each trip segment based on at least the first and last media objects associated with each trip segment (stage 230). The geo-referenced data depicts one or more users traveling between the geolocations associated with the first and last media objects. The geo-referenced data can include, for example, maps, 3D imagery, addresses, political designations, etc. Stage 230 may be carried out by, for example, media object organizer 104 or segment renderer 114 embodied in system 100.

Method 200 then combines one or more trip segments into an interactive tour (stage 240). Each trip segment is rendered to include the media objects and the geo-referenced data associated with a trip segment. Each trip segment is rendered according to a presentation style that is selected, in part, based on its associated media objects. Presentation styles describe how the media objects and the geo-referenced data is displayed in the video segment. In some embodiments, presentation styles are selected automatically based on the media objects included in the trip segment. In some embodiments, a presentation style is selected or modified by the user. Step 240 may be carried out by, for example, segment renderer 114 embodied in system 100.

### Example Media Segments

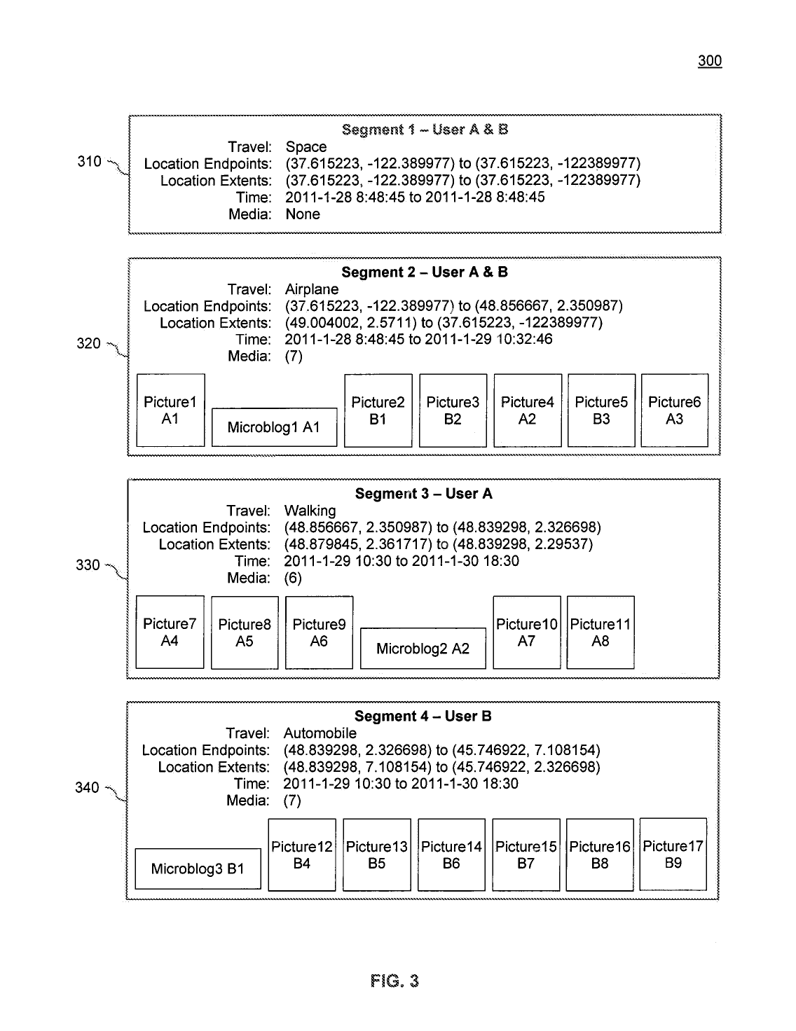

FIG. 3 illustrates an exemplary group of segments that is the result of clustering media objects according to an embodiment. Segment group 300 includes segment 310, segment 320, segment 330, and segment 340. Each segment is clustered based on the velocity value between each two adjacent media object falling into one or more velocity ranges. Segment group 300 includes the media objects picture1 though picture17 and microblog1 through microblog3. Picture1, picture4, picture6, and pictures7-11 are collected from user A's profile stored on social media server 144. Picture2, picture3, picture5, and pictures12-17 are collected from user B's profile stored on photo storage server 146. Micorblogs1-2 are collected from user A's profile stored on microblog server 140. Microblog3 is collected from user B's profile that is also stored on microblog server 140. After the media objects are collected, they are sorted based on when they were created or posted.

A distance value and a velocity value are then determined between adjacent media object. The media objects are clustered into trip segments based on the velocity value between each two adjacent media object and the user associated with each media object. Segment 310 is a default segment that may be included in some embodiments. It is intended to be used as a starting point for a digital video that incorporates segment group 300.

Segment 320 includes the media objects associated with velocity values above 100 miles per hour. This velocity range indicates that an airplane was the most likely mode of transportation. Because both user A and user B had a contiguous group of media objects that corresponded to velocity values over 100 miles per hour, their media objects were clustered into a single segment.

Segment 330 includes the media objects associated with velocity values between 1 mile per hour and 5 miles per hour. This velocity range indicates that walking was the most likely mode of transportation. Because only user A had corresponding media objects with velocity values between 1 and 5 miles per hour, only user A's media objects were included in segment 330.

Segment 340 includes media objects associated with velocity values between 20 miles per hour and 100 miles per hour. This velocity value range indicates that an automobile was the most likely mode of transportation. Because only user B had corresponding media objects with velocity values between 20 and 100 miles per hour, only user B's media objects were included in segment 340.

Segment group 300 is provided as an example and is not intended to limit the embodiments described herein.

### Example Video Layout

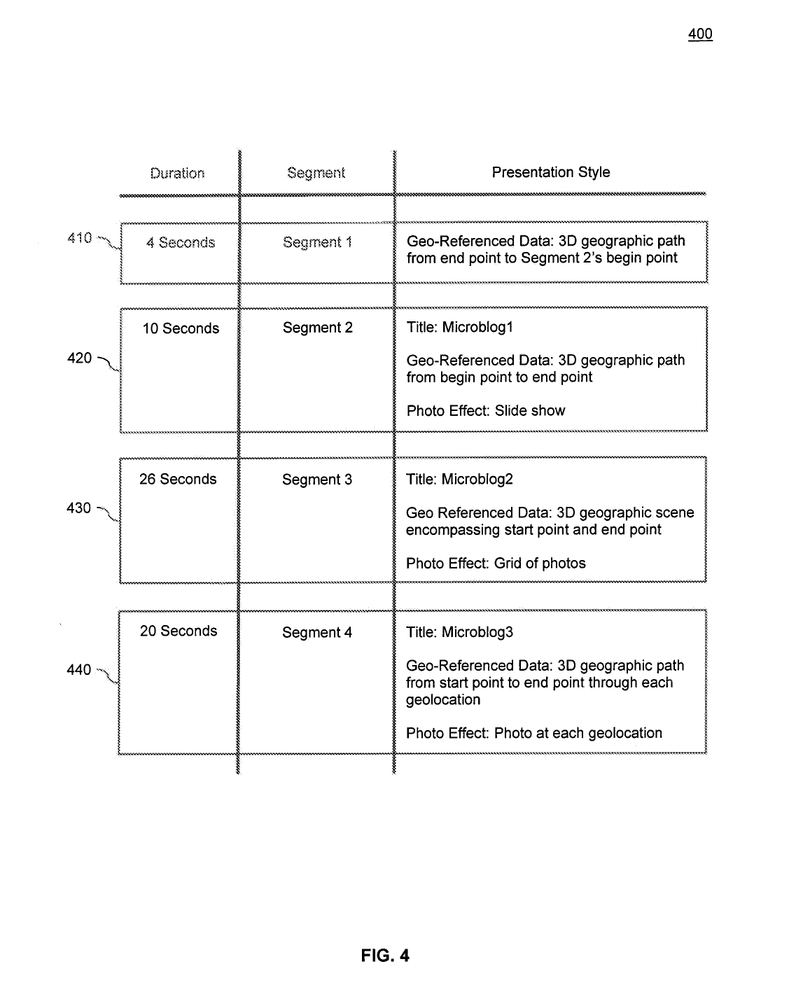

FIG. 4 illustrates an exemplary storyboard 400 that represents a geo-referenced digital video that is generated according to an embodiment. Storyboard 400 includes video segment 410, video segment 420, video segment 430, and video segment 440. Video segment 410 is rendered from trip segment 310 embodied in FIG. 3. Like trip segment 310, video segment 410 is provided as a default starting point. It includes a geo-referenced data movie that navigates from the segment 310's ending point to trip segment 320's starting point along a 3D virtual landscape.

Video segment 420 is rendered from trip segment 320 embodied in FIG. 3. Video segment 420 is rendered according to a presentation style that is selected based on trip segment 320's mode of transportation being an airplane. The presentation style utilizes microblog1 as the title and presents the photographic images as a slideshow. The slideshow and title are overlaid on a geo-referenced digital movie that navigates between trip segment 320's starting and ending points along a virtual 3D geographic landscape. Video segment 320's duration is determined by comparing the duration between the time values of the media objects included in the other segments with the duration between the time values of trip segment 320's media objects.

Video segment 430 is rendered from trip segment 330 embodied in FIG. 3. Video segment 430 is rendered according to a presentation style that was selected based a combination of the mode of transportation being walking and numerous photographic images. The presentation style utilizes microblog2 as the title and presents the photographic images in a grid. The size and shape of the grid is chosen based on the number of photographic images included in trip segment 330. The photo grid and the title are overlaid on a geo-referenced digital movie that navigates around a central point that encompasses trip segment 330's starting and ending points. Video segment 430's duration is determined based on the duration between the time values associated with trip segment 330's media objects.

Video segment 440 is rendered from trip segment 340 embodied in FIG. 3. Video segment 440 is rendered according to a presentation style that is selected based on an automobile being the user's mode of transportation. The presentation style utilizes microblog3 as the title. The title is overlaid on a geo-referenced digital movie that navigates a path in a 3D virtual landscape. The path includes points on the landscape that correspond to each photographic image's geolocation. As each point is traversed along the path, its corresponding photographic image is displayed. Video segment 440's duration is determined based on the duration between the time values associated with trip segment 340's media objects.

Each video segment in storyboard 400 is combined to generate a digital video. The video segments may be combined by, for example, segment renderer 114 embodied in FIG. 1. Storyboard 400 is included only as an example and is not intended to limit the embodiments described herein.

### Example Computer System

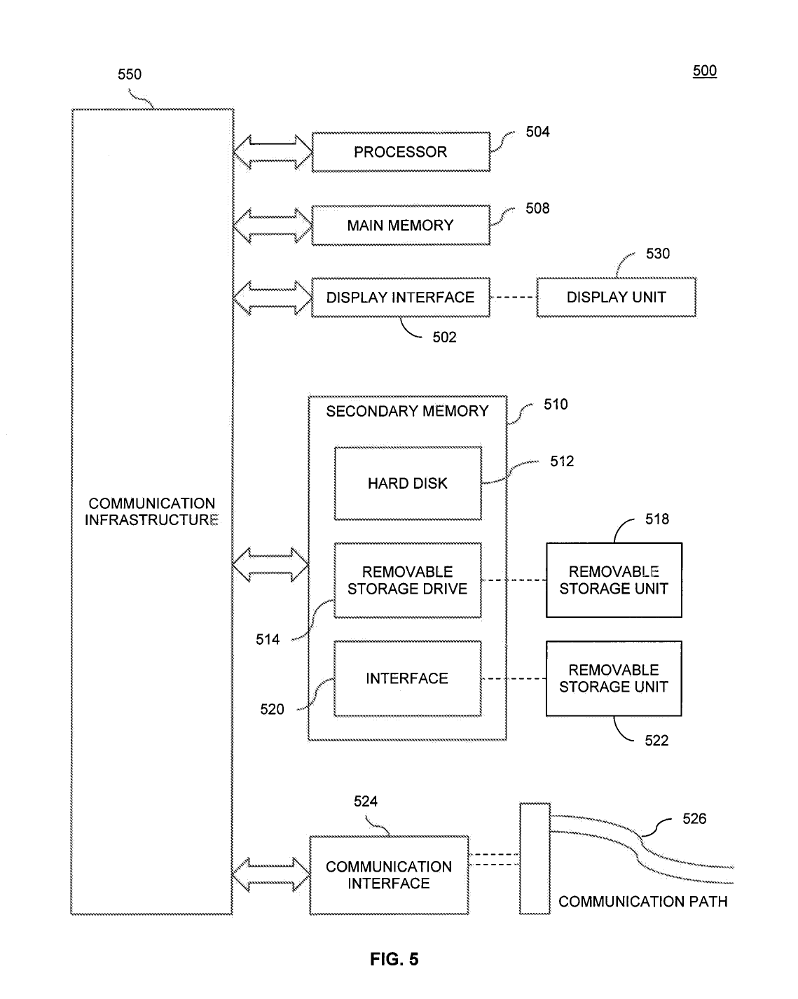

FIG. 5 illustrates an example computer system 500 in which embodiments of the present disclosure, or portions thereof, may be implemented. For example, media object collector 102, media object organizer 104, segment labeller 112, segment renderer 114, user-interface module 118, and media distributer 116 may be implemented in one or more computer systems 500 using hardware, software, firmware, computer readable storage media having instructions stored thereon, or a combination thereof.

One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above described embodiments. A processor device may be a single processor, a plurality of processors, or combinations thereof. Processor devices may have one or more processor “cores.”

Various embodiments are described in terms of this example computer system 500. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 504 may be a single processor in a multi-core/multiprocessor system, such system operating alone, or in a cluster of computing devices operating in a cluster or server farm. Processor device 504 is connected to a communication infrastructure 506, for example, a bus, message queue, network, or multi-core message-passing scheme.

Computer system 500 also includes a main memory 508, for example, random access memory (RAM), and may also include a secondary memory 510. Secondary memory 510 may include, for example, a hard disk drive 512, and removable storage drive 514. Removable storage drive 514 may include a floppy disk drive, a magnetic tape drive, an optical disk drive, a flash memory drive, or the like. The removable storage drive 514 reads from and/or writes to a removable storage unit 518 in a well-known manner. Removable storage unit 518 may include a floppy disk, magnetic tape, optical disk, flash memory drive, etc. which is read by and written to by removable storage drive 514. As will be appreciated by persons skilled in the relevant art, removable storage unit 518 includes a computer readable storage medium having stored thereon computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 may be in the form of signals, which may be electronic, electromagnetic, optical, or other signals capable of being received by communications interface 524. These signals may be provided to communications interface 524 via a communications path 526. Communications path 526 carries signals and may be implemented using wire or cable, fiber optics, a phone line, a cellular phone link, an RF link or other communications channels.

In this document, the terms “computer storage medium” and “computer readable storage medium” are used to generally refer to media such as removable storage unit 518, removable storage unit 522, and a hard disk installed in hard disk drive 512. Computer storage medium and computer readable storage medium may also refer to memories, such as main memory 508 and secondary memory 510, which may be memory semiconductors (e.g. DRAMs, etc.).

Computer programs (also called computer control logic) are stored in main memory 508 and/or secondary memory 510. Computer programs may also be received via communications interface 524. Such computer programs, when executed, enable computer system 500 to implement the embodiments described herein. In particular, the computer programs, when executed, enable processor device 504 to implement the processes of the embodiments, such as the stages in the methods illustrated by flowchart 200 of FIG. 2, discussed above. Accordingly, such computer programs represent controllers of computer system 500. Where an embodiment is implemented using software, the software may be stored in a computer storage medium and loaded into computer system 500 using removable storage drive 514, interface 520, and hard disk drive 512, or communications interface 524.

Embodiments of the invention also may be directed to computer program products including software stored on any computer readable storage medium. Such software, when executed in one or more data processing device, causes a data processing device(s) to operate as described herein. Examples of computer readable storage mediums include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

### CONCLUSION

The Summary and Abstract sections may set forth one or more but not all exemplary embodiments as contemplated by the inventor(s), and thus, are not intended to limit the present invention and the appended claims in any way.

The foregoing description of specific embodiments so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

1. A computer-implemented method for requesting a geo-referenced interactive tour using media objects collected from a plurality of users comprising:
in response to a request from a user to generate the interactive tour:
accessing, by one or more computing devices, a plurality of selected user profiles, wherein each user profile is associated with one or more users, and wherein each user profile hosts one or more media objects stored on at least one media source, the one or more computing devices comprising one or more processors;
clustering, by the one or more computing devices, one or more media objects hosted by each selected user profile into one or more trip segments based on a velocity value associated with each media object, the velocity value indicating the velocity of travel between two media objects, wherein each trip segment includes a first media object representing a start of the trip segment and a last media object representing an end of the trip segment;
collecting, by the one or more computing devices, geo-referenced data for at least one trip segment based on at least the first media object and the last media object associated with the trip segment, wherein the geo-referenced data is collected from a geographic information system separate from the plurality of selected user profiles and depicts one or more users traveling between the geolocation associated with the first media object and the geolocation associated with the last media object, the geo-referenced data comprising information that corresponds to the geolocation associated with the first media object and the geolocation associated with the last media object, wherein the information is different from the one or more media objects hosted by each selected user profile;
combining, by the one or more computing devices, one or more rendered trip segments into the interactive tour, wherein each trip segment is rendered to include its associated media objects and georeferenced data, and wherein the trip segment is rendered according to a presentation style that is selected, in part, based on its associated media objects.

2. The computer-implemented method of claim 1, wherein at least one trip segment is further clustered based on the user profile associated with a media object.

3. The computer-implemented method of claim 1, wherein at least one trip segment is further clustered based on one or more users associated with a media object.

4. The computer-implemented method of claim 1, further comprising:
receiving a start time and an end time, wherein the start time and the end time describe a time range; and
wherein the media objects are further clustered based on the time value associated with each media object falling within the time range.

5. The computer-implemented method of claim 1, wherein the at least one media source is limited to a group of selected media sources.

6. The computer-implemented method of claim 1, further comprising:
rendering the interactive tour into a digital video.

7. The computer-implemented method of claim 6, further comprising:
receiving a video duration, wherein the video duration is used to determine the digital video's duration.

8. The computer-implemented method of claim 6, further comprising:
determining a duration for at least one trip segment included in the digital video based on the time value associated with the first and last media objects included in the trip segment.

9. The computer-implemented method of claim 1, further comprising:
labeling each trip segment based on the geolocation associated with at least one media object included in the trip segment.

10. The computer-implemented method of claim 1, wherein a trip segment indicates a mode of transportation, the mode of transportation including one of flying, driving, walking, boating, biking, or remaining stationary, and wherein the mode of transportation is determined from the velocity value associated with media objects included in the trip segment.

11. A system for requesting a geo-referenced interactive tour using media objects collected from a plurality of users comprising:
at least one processor;
a media object collector configured to be executed on the at least one processor and that accesses a plurality of selected user profiles, wherein each user profile is associated with one or more users, and wherein each user profile hosts one or more media objects stored on at least one media source;
a media object organizer configured to be executed on the at least one processor and that:
clusters one or more media objects hosted by each selected user profile into one or more trip segments based on a velocity value associated with each media object, the velocity value indicating the velocity of travel between two media objects, wherein each trip segment includes a first media object representing a start of the trip segment and a last media object representing an end of the trip segment; and
collects geo-referenced data for at least one trip segment based on at least the first media object and the last media object associated with the trip segment, wherein the geo-referenced data is collected from a geographic information system separate from the plurality of selected user profiles and depicts one or more users traveling between the geolocation associated with the first media object and the geolocation associated with the last media object, the geo-referenced data comprising information that corresponds to the geolocation associated with the first media object and the geolocation associated with the last media object, wherein the information is different from the one or more media objects hosted by each selected user profile;
a segment renderer configured to be executed on the at least one processor and that combines one or more rendered trip segments into the interactive tour, wherein each trip segment is rendered to include its associated media objects and geo-referenced data, and wherein the trip segment is rendered according to a presentation style that is selected, in part, based on its associated media objects.

12. The system of claim 11, wherein the media object organizer is further configured to cluster at least one trip segment based on the user profile associated with a media object.

13. The system of claim 11, wherein the media object organizer is further configured to cluster at least one trip segment based on one or more users associated with a media object.

14. The system of claim 11, wherein the user-interface module is further configured to receive a start time and an end time, wherein the start time and the end time describe a time range, and wherein media object organizer is further configured to cluster the media objects based on the time value associated with each media object falling within the time range.

15. The system of claim 11, wherein the at least one media source is limited to a group of selected media sources.

16. The system of claim 11, wherein the segment renderer is further configured to render the interactive tour into a digital video.

17. The system of claim 16, further comprising:
a user-interface module configured to receive a video duration, wherein the video duration is used to determine the digital video's duration.

18. The system of claim 16, wherein the segment renderer is further configured to determine a duration for at least one trip segment based on the time value associated with the first and last media objects included in the trip segment.

19. The system of claim 11, further comprising:
a segment labeller configured to label each trip segment based on the geolocation associated with at least one media object included in the trip segment.

20. The system of claim 11, wherein a trip segment indicates a mode of transportation, the mode of transportation including one of flying, driving, walking, boating, biking, or remaining stationary, and wherein the mode of transportation is determined from the velocity value associated with media objects included in the trip segment.

21. A non-transitory computer-readable storage medium having instructions encoded thereon that, when executed by a computing device, causes the computing device to perform operations comprising:
in response to a request from a user to generate an interactive tour:
accessing a plurality of selected user profiles, wherein each user profile is associated with one or more users, and wherein each user profile hosts one or more media objects stored on at least one media source;
clustering one or more media objects hosted by each selected user profile into one or more trip segments based on a velocity value associated with each media object, the velocity value indicating the velocity of travel between two media objects, wherein each trip segment includes a first media object representing a start of the trip segment and a last media object representing an end of the trip segment;
collecting geo-referenced data for at least one trip segment based on at least the first media object and the last media object associated with the trip segment, wherein the geo-referenced data is collected from a geographic information system separate from the plurality of selected user profiles and depicts one or more users traveling between the geolocation associated with the first media object and the geolocation associated with the last media object, the geo-referenced data comprising information that corresponds to the geolocation associated with the first media object and the geolocation associated with the last media object, wherein the information is different from the one or more media objects hosted by each selected user profile;
combining one or more rendered trip segments into the interactive tour, wherein each trip segment is rendered to include its associated media objects and geo referenced data, and wherein the trip segment is rendered according to a presentation style that is selected, in part, based on its associated media objects.

22. The computer-readable storage medium of claim 21, wherein at least one trip segment is further clustered based on the user profile associated with a media object.

23. The computer-readable storage medium of claim 21, wherein at least one trip segment is further clustered based on one or more users associated with a media object.

24. The computer-readable storage medium of claim 21, further comprising:
receiving a start time and an end time, wherein the start time and the end time describe a time range; and
wherein the media objects are further clustered based on the time value associated with each media object falling within the time range.

25. The computer-readable storage medium of claim 21, wherein the at least one media source is limited to a group of selected media sources.

26. The computer-readable storage medium of claim 21, further comprising:
rendering the interactive tour into a digital video.

27. The computer-readable storage medium of claim 26, further comprising:
receiving a video duration, wherein the video duration is used to determine the digital video's duration.

28. The computer-readable storage medium of claim 26, further comprising:
determining a duration for at least one trip segment included in the digital video based on the time value associated with the first and last media objects included in the trip segment.

29. The computer-readable storage medium of claim 21, further comprising:
labeling each trip segment based on the geolocation associated with at least one media object included in the trip segment.

30. The computer-readable storage medium of claim 21, wherein a trip segment indicates a mode of transportation, the mode of transportation including one of flying, driving, walking, boating, biking, or remaining stationary, and wherein the mode of transportation is determined from the velocity value associated with media objects included in the trip segment.

31. A computer-implemented method for requesting a geo-referenced digital video using media objects collected from a plurality of users comprising:
in response to a request from a user to generate the digital video:
accessing a plurality of selected user profiles, wherein each user profile is associated with one or more users, and wherein each user profile hosts one or more media objects stored on at least one media source;
clustering one or more media objects hosted by each selected user profile into one or more trip segments based on a velocity value associated with each media object, the velocity value indicating the velocity of travel between two media objects, wherein each trip segment includes a first media object representing a start of the trip segment and a last media object representing an end of the trip segment;
collecting geo-referenced data for at least one trip segment based on at least the first media object and the last media object associated with the trip segment, wherein the geo-referenced data is collected from a geographic information system separate from the plurality of selected user profiles and depicts one or more users traveling between the geolocation associated with the first media object and the geolocation associated with the last media object, the geo-referenced data comprising information that corresponds to the geolocation associated with the first media object and the geolocation associated with the last media object, wherein the information is different from the one or more media objects hosted by each selected user profile;
rendering one or more trip segments into the digital video, wherein each trip segment is rendered to include its associated media objects and geo-referenced data, and wherein the trip segment is rendered according to a presentation style that is selected, in part, based on its associated media objects.
